(19) United States
(12) Patent Application Publication
(10) Pub. No.: US 2008/0127069 A1
(43) Pub. Date: May 29, 2008

(54) Reusable class library for multi-threaded application

(75) Inventor: Valeriy Ryazanov, Plano, TX (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Aspect Software, Inc., Westford, MA (US)

(21) Appl. No.: 11/549,344

(22) Filed: Oct. 13, 2006

(51) Int. Cl. G06F 9/44

(52) U.S. Cl. 717/116

(57) ABSTRACT

A method, system, and computer program product for providing of server-based objects automated memory management in multithreaded, object-oriented programming applications through the use of a reusable class library. The exemplary method derives a new object class from the generic base object class to provide the new object class with smart pointer functionality. The exemplary method type-defines the generic template class to the new object class automated reference counting functionality thereby creating a proxy object. In embodiments, the object-oriented programming language may be C++. The exemplary method provides automated reference counting combined with the use of smart pointers to achieve automated memory management of server-based objects.

### TECHNICAL FIELD

The invention relates to object-oriented programming languages. More particularly, the invention relates to automated memory management of server-based objects in multithreaded applications through the use of a reusable class library.

### BACKGROUND INFORMATION

Object-oriented programming (OOP) is a class of programming languages that are based on the concept of an “object”. An object is a self-contained component designed to complete specified tasks in a program. Java, C#, and C++ are all examples of OOP languages.

OOP languages define classes of objects. A “class” is a prototype for an object, or a set of objects that have a common structure and behavior. An object, also referred to as an “instance”, is a specific representation of a class. Each instance of a class has particular attributes, which are called “instance variables”. The types and names of the instance variables are defined for each class, but the individual values of the instance variables are set and changed in the object.

Accessing data in an object-oriented database may be performed in some systems, such as C++, by the use of “pointers”. A pointer identifies the physical location of data within a block of memory. Obtaining the value that a pointer refers to is called dereferencing the pointer. The heap is the memory location from which newly created objects or classes are allocated. When an application has no further need for an object, the memory allocated for that object should be released for future use. In C++, pointers can be manually manipulated with functions such as AddReference and RemoveReference, which can be used to help identify when a pointer should “destroy” itself. Essentially an integer value assigned to the pointer gets incremented up and down as an object's pointer is passed around from one application to another until the integer value of the pointer becomes zero. When the value becomes zero, the pointer destroys itself and the memory location is no longer allocated for that object. With the use of pointers, reference counting and memory management are both performed manually through the programmer's code. The management of pointers can be time-consuming during development and can also lead to various undesirable outcomes if mistakes are made in either reference counting or memory management. Failure to properly perform either task can lead to increased development time, unwanted memory leaks, or application crashes.

Smart pointers were created to reduce the frequency of memory management errors related to the use of pointers. A smart pointer functions like a pointer except that it also automatically deallocates the memory associated with an object at the appropriate time, i.e. when the object is no longer needed. Smart pointers can also be used to maintain reference counting of dynamically allocated objects shared by multiple owners. This can be beneficial in multi-threaded applications in which several applications are being executed simultaneously. However, it can be cumbersome and time-consuming in the development stage because reference counting is still done manually through calling functions such as AddReference and RemoveReference in the programmer's code. And memory management errors still exist related to the use of smart pointers. There is a clear need for a less cumbersome and more reliable technique than the use of smart pointers especially when multi-threaded applications are involved.

### SUMMARY

Accordingly, the present invention is a novel method for providing automated memory management of server-based objects through the use of a reusable class library. The problems of accurately maintaining object pointer values are solved by using a class library to create a proxy object, which encapsulates the object along with smart pointer functionality and automated reference counting functionality. This allows reference counting to be maintained automatically as the proxy object is passed from one thread to another during simultaneous execution of multiple threads. The memory allocated to the object is automatically made available for other uses once the object is no longer needed.

In accordance with the present invention, a method of automating the memory management of server-based objects is disclosed. Initially, a new class is derived from a generic base class. The new class inherits smart pointer functionality from its base class. This is followed by the creation of a proxy object, which essentially contains the new (derived) class encapsulated in a memory management template. To achieve this, a generic template class is type-defined to the new (derived) class which “gives” the new class automated reference counting functionality. The generic template class may be part of the class library. From this point on, the reference counting on the object, i.e. the new (derived) class, is maintained automatically. The coding is significantly simplified from the use of smart pointers alone, and the object's memory location is accurately managed especially during multi-threaded applications.

### BRIEF DESCRIPTION OF THE DRAWINGS

These and other features and advantages of the present invention will be better understood by reading the following detailed description, taken together with the drawings wherein:

FIG. 1 is a diagram illustrating the relationship between a generic base class and a new class derived from that base class.

FIG. 2A is a diagram illustrating an exemplary embodiment of a generic template class that is type-defined to a new (derived) class.

FIG. 2B is a diagram illustrating an exemplary embodiment of a proxy object which is passed from thread to thread simultaneously in multi-threaded applications.

FIG. 3 is a diagram showing the role of the proxy object in automated memory management while a multi-threaded application is processed according to an embodiment of the present invention.

FIG. 4 is a block diagram of an exemplary method for automating the management of memory allocation for an object or class according to an embodiment of the present invention.

### DETAILED DESCRIPTION

The invention provides a method for automatically managing memory allocations of server-based objects in multithreaded applications. Preferred embodiments of the invention may utilize a reusable class library to create a proxy object. This proxy object essentially includes a new class along with the functionality of smart pointers and the functionality of automated reference counting. These combined functionalities allow the new class to accurately and automatically “destroy” the memory allocated to the said class once it is no longer needed.

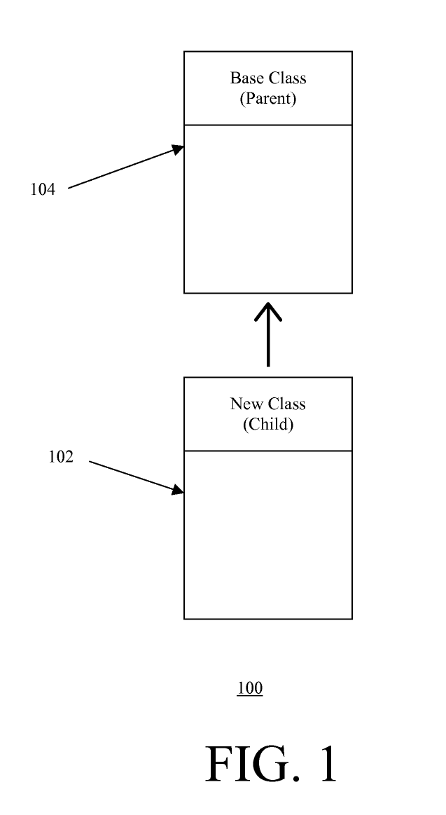

Referring to FIG. 1, an exemplary embodiment of the invention begins with a generic base class 104. The generic base class contains smart pointer functionality. Now a new class 102 is derived from the generic base class 104. The new class 102 will now inherit the smart pointer functionality in addition to the object contained in the new class 102. The generic base class 104 may also be referred to as the parent class or the superclass. The new class 102 may also be referred to as the child class or the subclass. In object-oriented programming, the child class or subclass will have more functionality than the parent class or superclass.

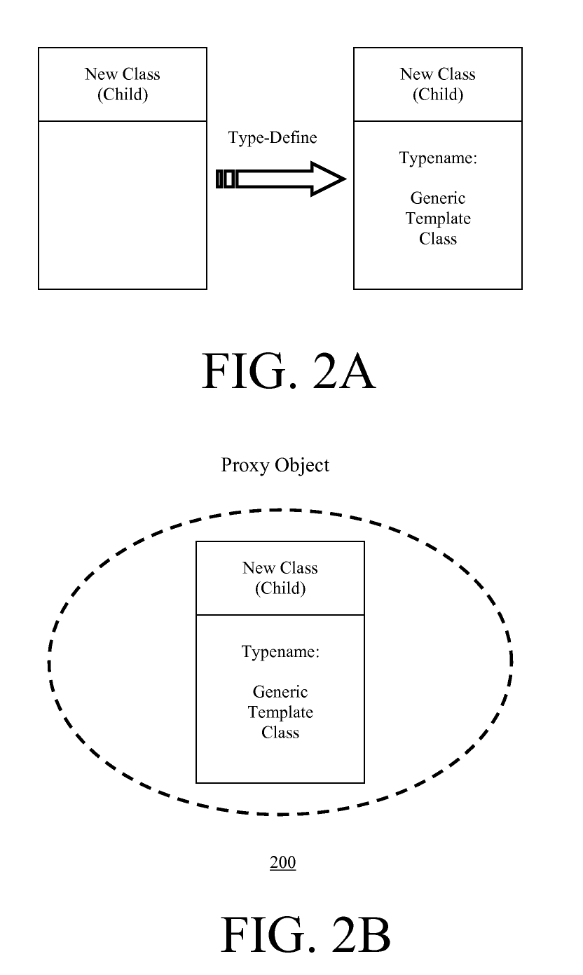

Referring to FIGS. 2A and 2B, an exemplary embodiment of the invention may utilize the type-define declaration to give the new class a new type name, e.g. generic template class. With this new type name, the new class inherits all the functionality of the said type name. In an exemplary embodiment, the functionality contained in the new type name may be automated reference counting functionality. The reference counting on the new class object is maintained automatically without the need for manually calling functions such as AddReference and RemoveReference. A proxy object 200 with both smart pointer functionality and automated reference counting functionality is thus created.

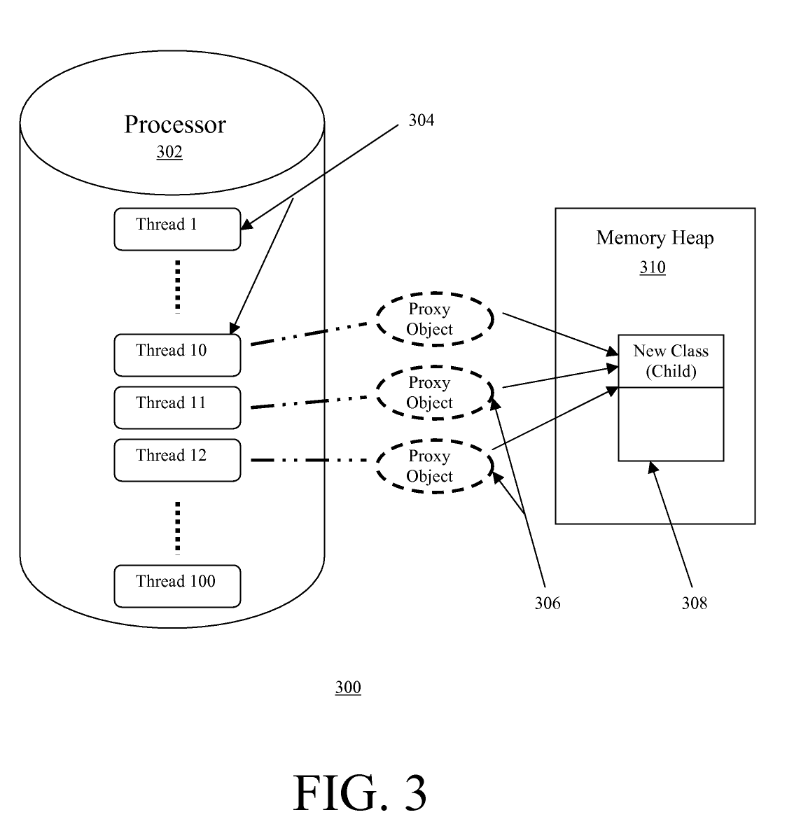

Referring to FIG. 3, an exemplary embodiment of the invention may be used in multithreaded applications where a processor 302 is executing numerous threads 304 simultaneously. Several threads may be referencing a proxy object 306 at overlapping times. This proxy object 306 contains the object from a new class 308 as well as smart pointer functionality and automated reference counting functionality. Due to having both of the said functionalities, once the new class object is no longer needed the memory allocated to the new class object may be automatically made available for other uses, i.e. the object “destroys” itself. Newly created objects or instances are allocated memory from the memory heap 310.

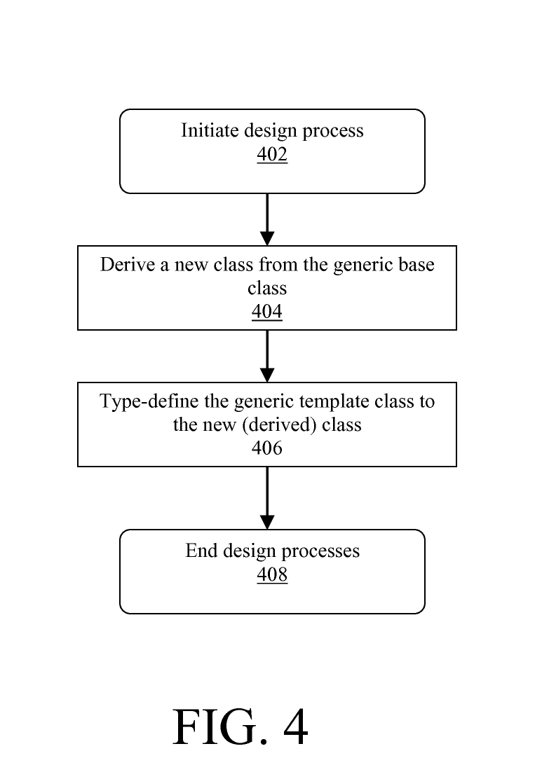

Referring to FIG. 4, a block diagram illustrates aspects of an exemplary method for automatically managing memory allocations of server-based objects in multithreaded applications. The design process is initiated by the programmer developing code (block 402). The design process may be manually initiated by the programmer selecting the option from a menu. In another embodiment, the process may also be automatically initiated in response to another function or task performed by the programmer. A new class is derived from the generic base class (block 404). The generic template class is type-defined to the new (derived) class (block 406). The design process may be completed by the programmer (block 408).

The exemplary embodiments described herein can be implemented in digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, communications processing apparatus, e.g., a processing device, a computer, or multiple computers. A computer program can be written in a variety of programming languages, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a device or method which must satisfy one or more of any stated or implied object or feature of the invention and is not limited to the exemplary or primary embodiments described herein. Modifications and substitutions by one of ordinary skill in the art are considered to be within the scope of the present invention.

The invention claimed is:

1. A method for providing of server-based objects automated memory management in multithreaded, object-oriented programming applications through the use of a reusable class library, the method comprising steps of:
deriving a new object class from the generic base object class to provide the new object class with smart pointer functionality; and
type-defining the generic template class to the new object class automated reference counting functionality thereby creating a proxy object.

2. The method of claim 1, further comprising the steps of:
calling the generic base object class and the generic template class from the reusable class library.

3. The method of claim 1, wherein said object-oriented programming language is C++.

4. The method of claim 1, wherein deriving a new class involves generating an exact copy of the generic base class.

5. The method of claim 1, wherein said reusable class library provides automated reference counting.

6. The method of claim 1, wherein destruction of an object in the generic base object class by an executing thread does not effect a simultaneously executing thread accessing an associated object of the reusable class library.

7. The method of claim 1, further comprising the steps of:
calling an object in a multithreaded application from the new object class functioning as the reusable class library.

8. A system for providing of server-based objects automated memory management in multithreaded, object-oriented programming applications through the use of a reusable class library, the system comprising:
a module for deriving a new object class from the generic base object class to provide the new object class with smart pointer functionality; and
a module for type-defining the generic template class to the new object class automated reference counting functionality thereby creating a proxy object.

9. The system of claim 8, further comprising the steps of:
calling the generic base object class and the generic template class from the reusable class library.

10. The system of claim 8, wherein said object-oriented programming language is C++.

11. The system of claim 8, wherein deriving a new class involves generating an exact copy of the generic base class.

12. The system of claim 8, wherein said reusable class library provides automated reference counting.

13. The system of claim 8, wherein destruction of an object in the generic base object class by an executing thread does not effect a simultaneously executing thread accessing an associated object of the reusable class library.

14. The system of claim 8, further comprising the steps of:
calling an object in a multithreaded application from the new object class functioning as the reusable class library.

15. A computer program product, tangibly embodied in an information carrier, for providing of server-based objects automated memory management in multithreaded, object-oriented programming applications through the use of a reusable class library, the computer program product being operable to cause a machine to:
derive a new object class from the generic base object class to provide the new object class with smart pointer functionality; and
type-define the generic template class to the new object class automated reference counting functionality thereby creating a proxy object.

16. The computer program product of claim 15, further comprising the steps of:
calling the generic base object class and the generic template class from the reusable class library.

17. The computer program product of claim 15, wherein said object-oriented programming language is C++.

18. The computer program product of claim 15, wherein deriving a new class involves generating an exact copy of the generic base class.

19. The computer program product of claim 15, wherein said reusable class library provides automated reference counting.

20. The computer program product of claim 15, wherein destruction of an object in the generic base object class by an executing thread does not effect a simultaneously executing thread accessing an associated object of the reusable class library.

21. The computer program product of claim 15, further comprising the steps of:
calling an object in a multithreaded application from the new object class functioning as the reusable class library.
